(19) United States
(12) Patent Application Publication
(10) Pub. No.: US 2024/0128504 A1
(43) Pub. Date: Apr. 18, 2024

(54) PREPARATION METHOD AND APPLICATION OF FAST IONIC CONDUCTOR BASED ON IN-SITU POLYMERIZATION

(71) Applicant: YANGTZE DELTA REGION INSTITUTE OF UNIVERSITY OF ELECTRONIC SCIENCE AND TECHNOLOGY OF CHINA, HUZHOU, Huzhou (CN)

(72) Inventors: Mengqiang WU, Chengdu (CN); Ziqiang Xu, Chengdu (CN); Zixuan Fang, Chengdu (CN); Xingwei Zhang, Chengdu (CN)

(21) Appl. No.: 18/108,863

(22) Filed: Feb. 13, 2023

(30) Foreign Application Priority Data
Sep. 22, 2022 (CN) 202211159701.0

(51) Int. Cl. H01M 10/0565; C08F 2/04; C08F 2/44

(52) U.S. Cl. CPC H01M 10/0565; C08F 2/04; C08F 2/44; H01M 2300/0082; H01M 2300/0085

(57) ABSTRACT

Disclosed is a method for preparing fast ionic conductors based on in-situ polymerization, which uses the spatial resistance volume effect to widen ion migration channels by copolymerizing high spatial resistance monomers with highly reactive crosslinkers, resulting in shorter ion transport paths and substantially higher ionic conductivity of in-situ solid-state polymer electrolytes; also, the high spatial resistance monomers and highly reactive crosslinkers synergistically construct a three-dimensional network structure with both high mechanical strength and stable electrode electrolyte interface properties.

### CROSS-REFERENCE TO RELATED APPLICATIONS

This application claims priority to Chinese Patent Application No. 202211159701.0, filed on Sep. 22, 2022, the contents of which are hereby incorporated by reference.

### TECHNICAL FIELD

The present application relates to the technical field of solid-state electrolyte preparation, and in particular to a method for preparing fast ionic conductors based on in-situ polymerization and an application thereof.

### BACKGROUND

Renewable and clean energy sources such as solar, wind and tidal energy are necessary to develop as primary energy sources are gradually depleted and the environmental crisis is becoming increasingly serious. Yet, most of the above-mentioned renewable energy sources are intermittent energy, therefore new energy storage systems with high energy density and low losses are required for energy deployment. Lithium secondary batteries are widely used with abundant lithium resources and efficient energy storage and release capability; however, the current successfully commercialized lithium-ion liquid batteries have serious safety problems such as leakage and explosion, and are also insufficient to meet the current demand for energy storage systems. As a result, the development of solid-state electrolyte batteries with high energy density, high safety and high efficiency has become the promising orientation for the future development of lithium secondary batteries.

Solid-state electrolyte batteries include both inorganic solid-state batteries and polymer solid-state batteries. Though having high ionic conductivity and excellent lithium dendrite suppression, inorganic solid-state electrolytes are restricted from large-scale commercial application due to their brittleness, difficulty in mass production, and poor interfacial compatibility. Polymer solid state electrolytes are further divided into in-situ solid-state polymer electrolytes (ISPE) and ex-situ solid-state polymer electrolytes (ESPE), of which ISPE has better application prospects than ESPE due to its simple production process, environmentally friendly preparation process, ultra-low interfacial impedance, excellent interfacial compatibility and long cycling capability.

In spite of a certain level of development of ISPE technology, there are still difficulties in balancing high ionic conductivity, mechanical strength and electrode electrolyte interface properties. Solid-state polymer electrolytes transport ions through the movement of polymer chain segments. Highly flexible solid-state polymer electrolytes are featured by low glass transition temperature and high ionic conductivity; they are also limited by low mechanical strength and insufficient rigidity, in addition to unstable interface between electrolyte and electrode, resulting in low cycle Coulombic efficiency and short cycle life in solid-state batteries. In contrast, solid-state polymer electrolytes with high crystallinity have high polymer regularity, with resulted high mechanical strength and stable interfacial properties, but the polymer chain segment is weak in motion, and the ion migration channel is narrow with a quite low ionic conductivity (10⁻⁵-10⁻⁷ siemens per centimeter, S/cm), making the solid-state polymer electrolytes with high crystallinity difficult to commercialize. Consequently, it is a major challenge to combine high ionic conductivity, high mechanical strength and stable interfacial properties as for developing ISPE.

### SUMMARY

The present application proposes a method for preparing fast ionic conductors based on in-situ polymerization and its application in response to the problems of balancing ionic conductivity, mechanical strength and interfacial stability of the current in-situ solid-state polymer electrolytes (ISPE) that exists in the background technology.

To achieve the above objectives, the present application adopts technical schemes as follows:
a method for preparing fast ionic conductors based on in-situ polymerization, including:
step 1, mixing 15-30 parts by mass of high steric hindrance monomer and 5-10 parts by mass of crosslinker, removing water by molecular sieve, then adding 5-10 parts by mass of lithium salt, mixing evenly, obtaining a mixed solution A and storing the obtained mixed solution A at 2-8 degree Celsius (° C.);
step 2, mixing 0.04-0.12 parts by mass of initiator and 49.96-79.88 parts by mass of plasticizer, stirring for 30-120 minutes (min), and uniformly mixing to obtain a mixed solution B;
step 3, mixing the mixed solution A obtained from step 1 with the mixed solution B obtained from step 2, and uniformly stirring to obtain a polymerization precursor solution; and
step 4, injecting the polymerization precursor solution prepared in step 3 into a cell with porous skeleton film, adding with 10-35 microliters (IL) per square centimeter (μL/cm²), followed by in-situ polymerization at 30-80° C. for 0.5 hours (h)-48 h to obtain a solid-state polymer fast ionic conductor.

Optionally, the high steric hindrance monomer is of one or more of the following structural formulas:

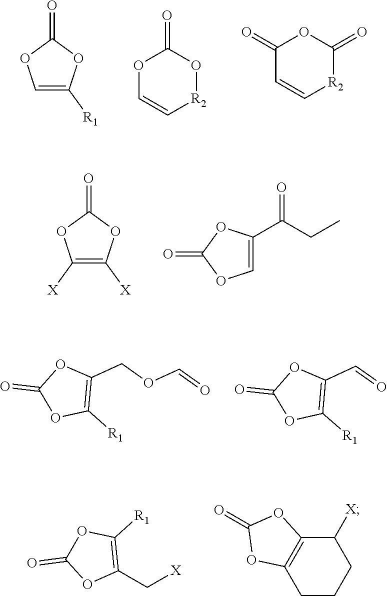

in which R₁ is H or —CH₃, R₂ is a carbon chain with less than 4 carbon atoms, and X is F, Cl, Br or I.

Optionally, the high steric hindrance monomer is one or more selected from a group of maleic anhydride, vinylene carbonate, dichlorovitone carbonate, 4,5-dim ethyl-1,3-dioxol-2-one, 4-chloromethyl-5-methyl-1,3-dioxol-2-one, olmesartan medoxomil impurity 83,4-bromomethane-1,3-dioxolane-2-one, and 4-tert-butyl-5-methyl-1,3-di oxolan-2-one.

Optionally, the crosslinker is an acrylic or a methacrylic crosslinker, preferably one or more selected from a group of 2-methyl-2-propenoic acid-2-oxirane-ethyl ester, poly(ethylene glycol) diacrylate, bisphenol A ethoxylate dimethacrylate, 2-methyl-acrylic acid-2-oxirane-ethyl, trimethylolpropane triacrylate, pentaerythritol tetraacrylate, and fluorinated phosphorus-based crosslinker.

Optionally, the lithium salt is one or more selected from a group of lithium hexafluorophosphate, lithium bis(trifluoromethyl)sulfonyl imide, lithium perchlorate, lithium bis(fluorosulfonyl)imide, lithium oxalate borate, lithium difluoroacetate, lithium tetrafluoroborate and lithium borate.

Optionally, the initiator includes one or more selected from a group of azobisisobutyronitrile, azoisobutyl cyanide, azodiisoheptylnitrile, benzoyl peroxide, Al(OTf)₃, lithium iodide and lithium hexafluorophosphate.

Optionally, the plasticizer is a 0.8-2 mole per liter (mol/L) lithium salt solution, with solute being one or more selected from a group of lithium hexafluorophosphate, lithium bis(trifluoromethyl)sulfonyl imide, lithium perchlorate, lithium bis(fluorosulfonyl)imide, lithium oxalate borate, lithium difluoroacetate, lithium tetrafluoroborate and lithium borate, in addition to solvent of one or more selected from a group of ethylene carbonate (EC), propylene carbonate (PC), dimethyl carbonate (DMC), ethyl methyl carbonate (EMC), diethyl carbonate (DEC), and 1,3-di oxolane (DOL).

Optionally, the cell with porous skeleton film in step 4 is obtained by laminating a cathode electrode sheet, a porous skeleton film and an anode electrode sheet in sequence and then encapsulating them with an aluminum-plastic film; among them, the cathode electrode sheet includes one of lithium iron phosphate, lithium nickelate, lithium cobaltate, lithium ferromanganese phosphate, lithium manganate, lithium nickel manganate, nickel cobalt manganese ternary cathode, and sulfur cathode as an active substance; the anode electrode sheet includes an active material of one of lithium metal flake, lithium metal alloy, graphite, hard carbon, molybdenum disulfide, lithium titanate, graphene, and silicon carbon anode; and the porous skeleton film is one selected from a group of polyethylene film, polypropylene film, lignocellulose film, glass fiber film, polyimide electrospun film, polyvinylidene fluoride electrospun film, and polyacrylonitrile electrospun film.

According to the method for preparing fast ionic conductors based on in-situ polymerization provided by the present application, the prepared solid-state polymer fast ionic conductor has structural characteristics and lithium ion transport mechanism as follows:

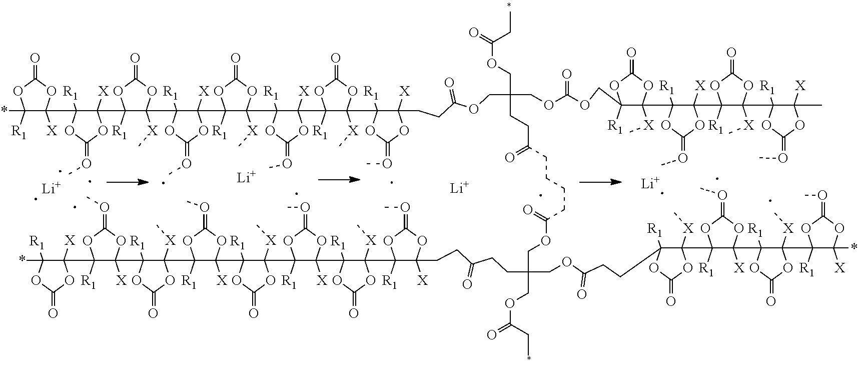

The lithium ions are transported by hopping on the COO⁻ and X⁻ group sites, and the continuous COO⁻ and X⁻ group sites make the lithium ion paths coherent.

Compared with the prior art, the present application has the advantages that:
the present application provides a method for preparing fast ionic conductors based on in-situ polymerization, which uses the spatial resistance volume effect to widen ion migration channels by copolymerizing high spatial resistance monomers with highly reactive crosslinkers, resulting in shorter ion transport paths and substantially higher ionic conductivity of ISPE; also, the high spatial resistance monomers and highly reactive crosslinkers synergistically construct a three-dimensional network structure with both high mechanical strength and stable electrode electrolyte interface properties, effectively solving the problem of difficulty in combining ionic conductivity, mechanical strength and interfacial stability of current ISPE; and the prepared fast ionic conductors can be applied to lithium secondary batteries, thereby effectively improving the energy density, coulombic efficiency and cycling stability of lithium secondary batteries and broadening the application fields of lithium secondary batteries.

### BRIEF DESCRIPTION OF THE DRAWINGS

FIG. 1 shows alternating current impedance curves for solid-state polymer fast ionic conductors obtained from Embodiment 1 and Comparative embodiment 1.

FIG. 2 shows linear sweep voltammetry curves of solid polymer fast ionic conductors obtained in Embodiment 2 and Comparative embodiment 2.

FIG. 3 illustrates the results of multiplicative performance tests of lithium secondary batteries assembled with solid-state polymer fast ionic conductor obtained in Embodiment 2.

FIG. 4 demonstrates the results of cycle performance tests of lithium secondary batteries assembled with solid-state polymer fast ionic conductors obtained in Embodiment 2.

### DETAILED DESCRIPTION OF THE EMBODIMENTS

The present application is further described hereinafter in connection with some of the embodiments and comparative embodiments. It should be noted that the specific embodiments described herein are intended only to explain the present application and are not intended to limit it.

A method for preparing lithium secondary batteries using fast ionic conductors based on in-situ polymerization, including:
S1, preparing a cathode, including:
S1.1, dissolving polyvinylidene fluoride (PVDF) at 5 weight percentage (wt. %) compared to a mass of anode material in nitrogen methylpyrrolidone (NMP) at 32 wt. % compared to a mass of total slurry and stirring for 1 hour (h) to obtain a PVDF solution at a stirring speed of 2,000 revolutions per minute (r/min);
S1.2, adding 5 wt. % conductive carbon black to the PVDF solution obtained in S1.1, and continuously stirring for 1 h at a rotating speed of 2,000 r/min to obtain a mixed solution; then adding an anode active substance of 90 wt. % compared to the mass of the cathode material to the obtained mixed solution, followed by continuously stirring for 2 h at a rotating speed of 2,000 r/min to obtain a slurry;
S1.3, subjecting the slurry obtained in S1.2 to vacuum for defoaming, and then filtering, followed by coating onto an aluminum foil, drying under 120 degree Celsius (° C.) and roller pressing, then storing in a vacuum oven at 80° C.; cutting into pieces when in use to obtain a cathode;
S2, preparing an anode, including:
S2.1, mixing anode active material, binder, conductive carbon black and deionized water in a mass ratio of 1:1:1:1 to obtain a slurry, followed by vacuum for deforming, and then filtering, and coating onto a copper foil, then drying at 120° C. and roller pressing; storing in a vacuum oven at 80° C.; cutting into pieces when in use to obtain an anode; the binder includes one selected from a group of carboxymethylcellulose (CMC), styrene butadiene rubber (SBR), polyacrylic acid (PAA) and LA132/LA133, and the anode material capacity is 1.01 to 1.05 times of the cathode material capacity;
S3, preparing a polymerization precursor solution of a solid-state polymer fast ionic conductor;
S4, laminating in a sequence of anode, porous skeleton film, and cathode, and encapsulating with aluminum-plastic film to obtain a cell with porous skeleton film; injecting the polymerization precursor solution prepared in S3 into the cell with porous skeleton film, with 10
35 microliters (μL) per square centimeter (μL/cm²), followed by in-situ polymerization at 30-80° C. for 0.5 h-48 h, and standing at room temperature for 12 h to obtain a lithium secondary battery.

The obtained lithium secondary battery is tested by a battery charge and discharge tester LAND.

Among them, the polymerization precursor solution of the solid-state polymer fast ionic conductor in S3 are prepared and applied as follows:

### Embodiment 1

In a dry glovebox filled with argon (O₂<0.1 parts per million (ppm), H₂O<0.1 ppm), 20 parts by mass of high steric hindrance monomer maleic anhydride and 5 parts by mass of high activity crosslinker poly(ethylene glycol)dimethacrylate (PEGDMA) are stirred and mixed; after water removal by molecular sieve, 5 parts by mass of lithium bis(fluorosulfonyl)imide is added and stirred for 30 minutes (min) to completely dissolve the lithium salt and obtain a mixed solution A, followed by storing at 2-8° C.; 0.04 mass part of initiator azobisisobutyronitrile (AIBN) and 69.96 mass parts of plasticizer (1 mole per liter (mol/L) lithium salt solution, lithium bis(fluorosulfonyl)imide as solute, mixed solvent of DOL and DMC with volume ratio of 1:1) are mixed, stirred for 40 min and evenly mixed to obtain a mixed solution B; the mixed solution A and the mixed solution B are mixed and stirred evenly to obtain a polymerization precursor solution.

The dried lithium cobaltate cathode and graphite anode are cut into pieces, laminated in an order of anode, porous skeleton film and cathode, and then packaged with aluminum-plastic film to obtain a cell with porous skeleton film, which is made of 100 micrometers (um) thick lignocellulose film; then, the polymerization precursor solution is injected into the cell with porous skeleton film by 35 μL/cm², followed by in-situ polymerization at 60° C. for 1 h, and standing at room temperature for 12 h to obtain a lithium secondary battery.

The lithium secondary battery obtained in Embodiment 1 has a first specific discharge capacity (1 C) of 125 milliampere-hour per gram (mAh/g), and an effective cycle number of 265.

### Embodiment 2

In a dry glovebox filled with argon (O₂<0.1 ppm, H₂O<0.1 ppm), 20 parts by mass of high steric hindrance monomer vinylene carbonate and 5 parts by mass of high activity crosslinker pentaerythritol tetraacrylate are stirred and mixed. After water removal by molecular sieve, 5 parts by mass of lithium bis(trifluoromethanesulphonyl)imide (LITFSI) is added and stirred for 30 min to completely dissolve the lithium salt to obtain a mixed solution A, which is stored at 2-8° C.; 0.04 mass part of initiator AIBN and 69.96 mass parts of plasticizer (1 mol/L lithium salt solution, with solute of bis(trifluoromethylsulfonyl)imide, and solvent of mixed solvent of DOL and DMC with a volume ratio of 1:1) are mixed, stirred for 40 min and evenly mixed to obtain a mixed solution B; the mixed solution A and the mixed solution B are mixed and stirred evenly to obtain a polymerization precursor solution.

The dried lithium iron phosphate cathode and lithium foil anode are cut into pieces, laminated in an order of anode, porous skeleton film and cathode, and then packaged with aluminum-plastic film to obtain a cell with porous skeleton film, which is made of 22 um thick polyimide electrospun film; then, the polymerization precursor solution is injected into the cell with porous skeleton by 35 μL/cm², followed by in-situ polymerization at 70° C. for 0.5 h, and standing at room temperature for 12 h to obtain a lithium secondary battery.

The lithium secondary battery obtained in Embodiment 2 has a first specific discharge capacity (1 C) of 150 mAh/g, and an effective cycle number of 320.

### Embodiment 3

In a dry glovebox filled with argon (O₂<0.1 ppm, H₂O<0.1 ppm), 15 parts by mass of high steric hindrance monomer olmesartan medoxomil impurity 83 and 5 parts by mass of phosphorus fluoride based crosslinker (FTGA), a high activity crosslinker, are stirred and mixed; after water removal by molecular sieve, 5 parts by mass of lithium hexafluorophosphate (LiPF₆) are added and stirred for 30 min to completely dissolve the lithium salt, then a mixed solution A is obtained and stored under 2-8° C.; 0.1 part by mass of ARM initiator and 74.9 parts by mass of plasticizer (1 mol/L lithium salt solution, with LiPF₆ as solute, mixed solvent of ethylene carbonate (EC) and diethyl carbonate (DEC) with volume ratio of 1:1) are mixed, followed by stirring for 40 min for evenly mixing and obtaining a mixed solution B; the mixed solution A and the mixed solution B are mixed and stirred evenly to obtain a polymerization precursor solution;

The dried ternary cathode NCM811 and graphite anode electrode are cut into pieces, and laminated in an order of anode, porous skeleton film and cathode, and then packaged with aluminum-plastic film to obtain a cell with porous skeleton film, which is made of 180 um thick glass fiber film; then, the polymerization precursor solution is injected into the cell with porous skeleton film with 35 μL/cm², followed by in-situ polymerization at 70° C. for 2 h, and standing at room temperature for 12 h to obtain a lithium secondary battery.

The lithium secondary battery obtained in Embodiment 3 has a first specific discharge capacity (1 C) of 165 mAh/g, and an effective cycle number of 180.

### Embodiment 4

In a dry glovebox filled with argon (O₂<0.1 ppm, H₂O<0.1 ppm), 25 parts by mass of high steric hindrance monomer 4-bromomethane-1,3-dioxolane-2-one and 5 parts by mass of highly active crosslinker trimethylolpropane triacrylate are stirred and mixed. After water removal by molecular sieve, 5 parts by mass of lithium difluoroacetate (LIDFOB) are added and stirred for 30 min, then a mixed solution A is obtained and stored under 2-8° C.; 0.09 mass part of benzoyl peroxide initiator and 64.91 mass parts of plasticizer (1 mol/L lithium salt solution, with lithium difluoroacetate as solute, and mixed solvent of propylene carbonate (PC), EC and DEC with volume ratio of 1:1:1) are mixed, followed by stirring for 40 min and evenly mixing to obtain a mixed solution B; the mixed solution A and the mixed solution B are mixed and stirred evenly to obtain a polymerization precursor solution.

The dried sulfur cathode and lithium foil anode are cut into pieces, and laminated in an order of cathode, porous skeleton film and anode, and then packaged with aluminum-plastic film to obtain a cell with porous skeleton film, which is a 20 um thick porous polypropylene film; then, the polymerization precursor solution is injected into the cell with porous skeleton film by 35 μL/cm², followed by in-situ polymerization at 80° C. for 1 h, and standing at room temperature for 12 h to obtain a lithium secondary battery.

The lithium secondary battery obtained in Embodiment 4 has a first specific discharge capacity (1 C) of 850 mAh/g, and an effective cycle number of 150.

### Comparative Embodiment 1

In a dry glovebox filled with argon (O₂<0.1 ppm, H₂O<0.1 ppm), 25 parts by mass of high activity oligomer PEGDMA and 5 parts by mass of lithium bis(fluorosulfonyl)imide are stirred for 30 min to completely dissolve the lithium salt, then a mixed solution A is obtained and stored at 2-8° C.; 0.04 mass part of initiator AIBN and 69.96 mass parts of plasticizer (1 mol/L lithium salt solution, with lithium bis(fluorosulfonyl)imide as solute, and mixed solvent of DOL and DMC with volume ratio of 1:1) are mixed and stirred for 40 min to obtain a mixed solution B; the mixed solution A and the mixed solution B are mixed and stirred evenly to obtain a polymerization precursor solution.

The dried lithium cobaltate cathode and graphite anode are cut into pieces, and laminated in an order of anode, porous skeleton film and cathode, and then packaged with aluminum-plastic film to obtain a cell with porous skeleton film, which is made of 100 um thick lignocellulose film; then, the polymerization precursor solution is injected into the cell with porous skeleton film by 35 μL/cm², followed by in-situ polymerization at 60° C. for 1 h, and standing at room temperature for 12 h to obtain a lithium secondary battery.

The lithium secondary battery obtained in Comparative embodiment 1 has a first specific discharge capacity (1 C) of 92 mAh/g, and an effective cycle number of 143.

### Comparative Embodiment 2

In a dry glovebox filled with argon (O₂<0.1 ppm, H₂O<0.1 ppm), 25 parts by mass of pentaerythritol tetraacrylate and 5 parts by mass of LITFSI are stirred for 30 min to completely dissolve the lithium salt, then a mixed solution A is obtained and stored at 2-8° C.; 0.04 mass part of initiator AIBN and 69.96 mass parts of plasticizer (1 mol/L lithium salt solution, with lithium bis(fluorosulfonyl)imide as solute, and mixed solvent of DOL and DMC with volume ratio of 1:1) are mixed, stirred for 40 min and evenly mixed to obtain a mixed solution B; the mixed solution A and the mixed solution B are mixed and stirred evenly to obtain a polymerization precursor solution.

The dried lithium iron phosphate cathode and lithium foil anode are cut into pieces, and laminated in an order of anode, porous skeleton film and cathode, and then packaged with aluminum-plastic film to obtain a cell with porous skeleton film, which is made of 22 um thick polyimide electrospun film; then, the polymerization precursor solution is injected into the cell with porous skeleton film, with 35 μL/cm², followed by in-situ polymerization at 70° C. for 0.5 h and standing at room temperature for 12 h to obtain a lithium secondary battery.

The lithium secondary battery obtained in Comparative embodiment 2 has a first specific discharge capacity (1 C) of 120 mAh/g, and an effective cycle number of 146.

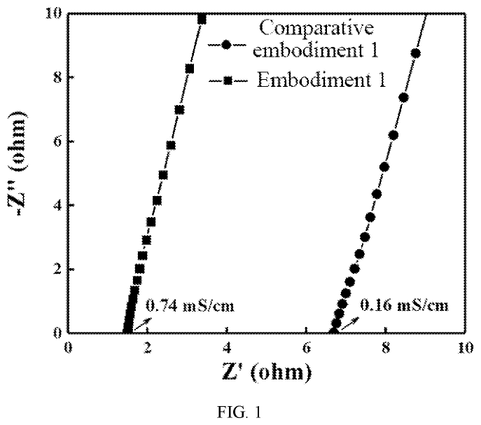

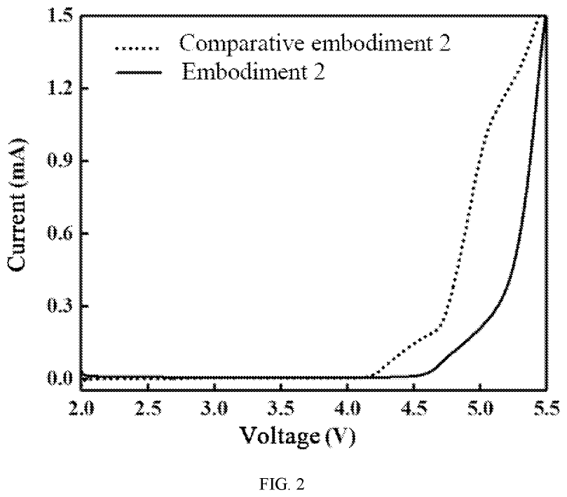

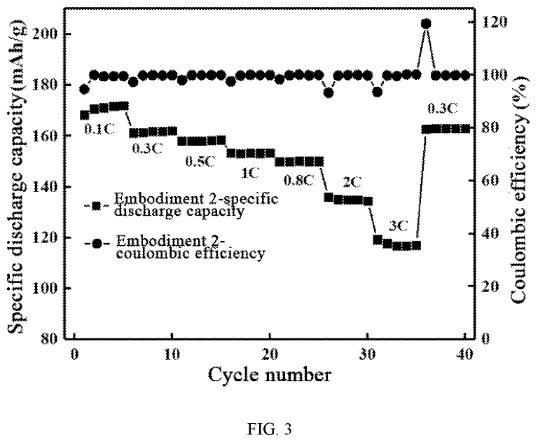

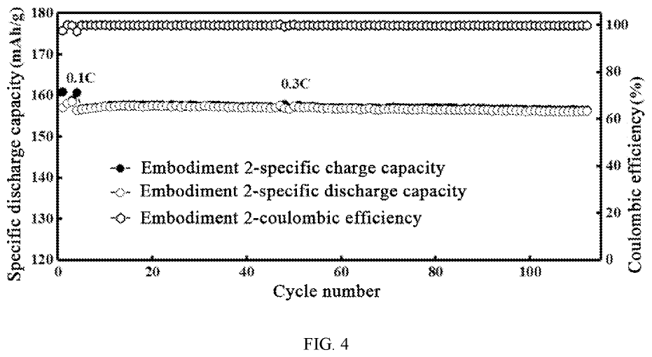

FIG. 1 illustrates alternating current (AC) impedance curves of solid-state polymer fast ionic conductors obtained from Embodiment 1 and Comparative embodiment 1; it can be seen form the FIG. 1 that the solid-state fast ionic conductor of the Embodiment has an exponential increase in ionic conductivity, indicating that the solid-state fast ionic conductor proposed by the present application is effective. FIG. 2 shows linear sweep voltammetry curves of solid-state polymer fast ionic conductors obtained in Embodiment 2 and Comparative embodiment 2; it shows that the electrochemical stability window of the solid-state fast ionic conductor in the embodiment is broadened compared to that of the comparative embodiment, indicating that the high spatial resistance monomer of the present application enables a more stable system of the in situ solid-state fast ionic conductor. FIGS. 3 and 4 show that the lithium secondary battery obtained from an embodiment of the present application has superior multiplicative performance and ability of long period cycling.

The above-described embodiments and comparative embodiments are only descriptions of the preferred way of the present application, which are not limited to the scope of the present application. Without departing from the design spirit of the present application, the field can be improved and optimized within the scope of the present application, and these improvements and optimizations shall also be regarded as the scope of protection of the present application.

What is claimed is:

1. A method for preparing fast ionic conductors based on in-situ polymerization, comprising:
step 1, mixing 15-30 parts by mass of high steric hindrance monomer and 5-10 parts by mass of crosslinker, removing water by molecular sieve, then adding 5-10 parts by mass of lithium salt, mixing evenly, obtaining a mixed solution A and storing the obtained mixed solution A at 2-8 degree Celsius (° C.);
step 2, mixing 0.04-0.12 parts by mass of initiator and 49.96-79.88 parts by mass of plasticizer, stirring for 30-120 minutes (min), and uniformly mixing to obtain a mixed solution B;
step 3, mixing the mixed solution A obtained from step 1 with the mixed solution B obtained from step 2, and uniformly stirring to obtain a polymerization precursor solution; and
step 4, injecting the polymerization precursor solution prepared in step 3 into a cell with porous skeleton film, adding with 10-35 microliters (μL) per square centimeter (μL/cm²), followed by in-situ polymerization at 30-80° C. for 0.5 hours (h)-48 h to obtain a solid-state polymer fast ionic conductor.

2. The method for preparing fast ionic conductors based on in-situ polymerization according to claim 1, wherein the high steric hindrance monomer is of one or more of the following structural formulas: 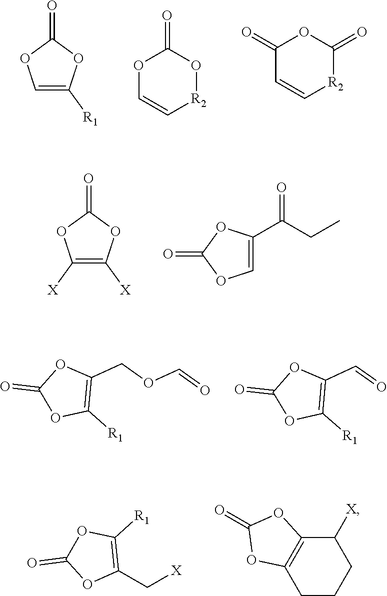
wherein R₁ is H or —CH₃, R₂ is a carbon chain with less than 4 carbon atoms, and X is F, Cl, Br or I.

3. The method for preparing fast ionic conductors based on in-situ polymerization according to claim 1, wherein the high steric hindrance monomer is one or more selected from a group of maleic anhydride, vinylene carbonate, dichlorovitone carbonate, 4,5-dim ethyl-1,3-dioxol-2-one, 4-chloromethyl-5-methyl-1,3-dioxol-2-one, olmesartan medoxomil impurity 83,4-bromomethane-1,3-di oxolane-2-one, and 4-tert-butyl-5-methyl-1,3-di oxolan-2-one.

4. The method for preparing fast ionic conductors based on in-situ polymerization according to claim 1, wherein the crosslinker is an acrylic or a methacrylic crosslinker.

5. The method for preparing fast ionic conductors based on in-situ polymerization according to claim 1, wherein the lithium salt is one or more selected from a group of lithium hexafluorophosphate, lithium bis(trifluoromethyl)sulfonyl imide, lithium perchlorate, lithium bis(fluorosulfonyl)imide, lithium oxalate borate, lithium difluoroacetate, lithium tetrafluoroborate and lithium borate.

6. The method for preparing fast ionic conductors based on in-situ polymerization according to claim 1, wherein the initiator comprises one or more selected from a group of azobisisobutyronitrile, azoisobutyl cyanide, azodiisoheptylnitrile, benzoyl peroxide, Al(OTf)₃, lithium iodide and lithium hexafluorophosphate.

7. The method for preparing fast ionic conductors based on in-situ polymerization according to claim 1, wherein the plasticizer is a 0.8-2 mole per liter (mol/L) lithium salt solution, with solute being one or more selected from a group of lithium hexafluorophosphate, lithium bis(trifluoromethyl)sulfonyl imide, lithium perchlorate, lithium bis(fluorosulfonyl)imide, lithium oxalate borate, lithium difluoroacetate, lithium tetrafluoroborate and lithium borate, in addition to solvent of one or more selected from a group of ethylene carbonate (EC), propylene carbonate (PC), dimethyl carbonate (DMC), ethyl methyl carbonate (EMC), diethyl carbonate (DEC), and 1,3-dioxolane (DOL).

8. The method for preparing fast ionic conductors based on in-situ polymerization according to claim 1, wherein the cell with porous skeleton film in step 4 is obtained by laminating a cathode electrode sheet, a porous skeleton film and an anode electrode sheet in sequence and then encapsulating them with an aluminum-plastic film.

9. The method for preparing fast ionic conductors based on in-situ polymerization according to claim 1, wherein the cathode electrode sheet comprises one of lithium iron phosphate, lithium nickelate, lithium cobaltate, lithium ferromanganese phosphate, lithium manganate, lithium nickel manganate, nickel cobalt manganese ternary cathode, and sulfur cathode as an active substance; the anode electrode sheet comprises an active material of one of lithium metal flake, lithium metal alloy, graphite, hard carbon, molybdenum disulfide, lithium titanate, graphene, and silicon carbon anode; and the porous skeleton film is one selected from a group of polyethylene film, polypropylene film, lignocellulose film, glass fiber film, polyimide electrospun film, polyvinylidene fluoride electrospun film, and polyacrylonitrile electrospun film.
